(19) United States
(12) Patent Application Publication
(10) Pub. No.: US 2015/0375915 A1
(43) Pub. Date: Dec. 31, 2015

(54) THERMOSTATIC PACKAGING MATERIALS

(71) Applicant: EMPIRE TECHNOLOGY DEVELOPMENT LLC, Wilmington, DE (US)

(72) Inventors: Angele Sjong, Louisville, CO (US); Kraig Anderson, Burlingame, CA (US)

(21) Appl. No.: 14/769,818

(22) PCT Filed: Apr. 18, 2013
(86) PCT No.: PCT/US13/37161

§ 371 Date: Aug. 23, 2015

(51) Int. Cl. B65D 81/18; B29C 65/00; C09K 5/06; B65B 3/00; B65B 63/08

(52) U.S. Cl. CPC B65D 81/18; B65B 3/003; B65B 63/08; C09K 5/063; C09K 5/066; B29C 65/002; B29K 2003/00; B29L 2009/00

(57) ABSTRACT

Technologies are generally provided for thermostatic packaging materials for packing temperature sensitive products such as foods, beverages, biological materials, pharmaceuticals, vaccines, and live organisms. The thermostatic packaging materials may be formed from a number of substrates in which thermo-responsive capsules may be suspended. The substrates may be composed from a gelatin film substrate in some examples. The thermo-responsive capsules may encapsulate a cooling agent for reducing a surrounding environmental temperature. The thermo-responsive capsules may be composed from a polymer such as poly N-isopropylacrylamide (PNIPAAm), which may be configured to release the encapsulated cooling agents when the surrounding environmental temperature reaches a threshold temperature. The substrates including the suspended thermo-responsive capsules encapsulating a cooling agent may be layered together to form a laminate having many cooling layers to provide a staged release mechanism to continuously provide a cooling effect for packaged materials.

### BACKGROUND

Unless otherwise indicated herein, the materials described in this section are not prior art to the claims in this application and are not admitted to be prior art by inclusion in this section.

In a consumer environment, temperature sensitive materials such as food, biological materials, and pharmaceuticals may be packaged and delivered to users all over the world employing various types of delivery services. It is often important to ensure that a constant temperature is maintained within a package by packaging the temperature sensitive materials with cold packs. Gelatin films are a commonly used material for applications requiring melting points at room temperature or below. However, some gelatin films may be thermally unstable at temperatures above thirty degrees Celsius, which may limit the application of gelatin as a packaging material for packing temperature sensitive materials.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present disclosure generally describes thermostatic packaging materials for maintaining a constant temperature of packaged products. The thermostatic packaging materials may include at least one substrate, a plurality of thermo-responsive capsules suspended within the substrate, and at least one cooling agent encapsulated within the thermo-responsive capsules.

According to other embodiments, the present disclosure describes methods of forming a thermostatic packaging material for maintaining a constant temperature of packaged products. The methods may include encapsulating a cooling agent within a plurality of thermo-responsive capsules, suspending the plurality of thermo-responsive capsules within a gelatin substrate film, and layering a plurality of gelatin film substrates including the suspended plurality of thermo-responsive capsules together to form a laminate.

According to further embodiments, the present disclosure describes thermostatic packaging materials for maintaining a constant temperature of packaged products. The thermostatic packaging materials may include at least one gelatin film substrate, a plurality of thermo-responsive polymer capsules suspended within the gelatin film substrate, and at least one cooling agent or a heating agent encapsulated within the thermo-responsive polymer capsules.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example substrate including thermo-responsive capsules;

FIG. 2 illustrates example release of a cooling agent from a thermo-responsive capsule;

FIG. 3 illustrates a sectional view of a laminate of substrate layers including thermo-responsive capsules;

FIG. 4 illustrates example packaging material formed from cut laminate;

FIG. 5 illustrates an example cylindrical packaging material formed from a rolled laminate; and

FIG. 6 illustrates an example schematic of forming thermostatic packaging materials from a layered laminate;

all arranged in accordance with at least some embodiments as described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to compositions, methods, apparatus, systems, devices, and/or computer program products related to manufacturing and using thermostatic polymer packaging.

Briefly stated, technologies are generally provided for thermostatic packaging materials for packing temperature sensitive products such as foods, beverages, biological materials, pharmaceuticals, vaccines, and live organisms. The thermostatic packaging materials may be formed from a number of substrates in which thermo-responsive capsules may be suspended. The substrates may be composed from a gelatin film substrate in some examples. The thermo-responsive capsules may encapsulate a cooling agent for reducing a surrounding environmental temperature. The thermo-responsive capsules may be composed from a polymer such as poly N-isopropylacrylamide (PNIPAAm), which may be configured to release the encapsulated cooling agents when the surrounding environmental temperature reaches a transition temperature. The substrates including the suspended thermo-responsive capsules encapsulating a cooling agent may be layered together to form a laminate having many cooling layers to provide a staged release mechanism to continuously provide a cooling effect for packaged materials.

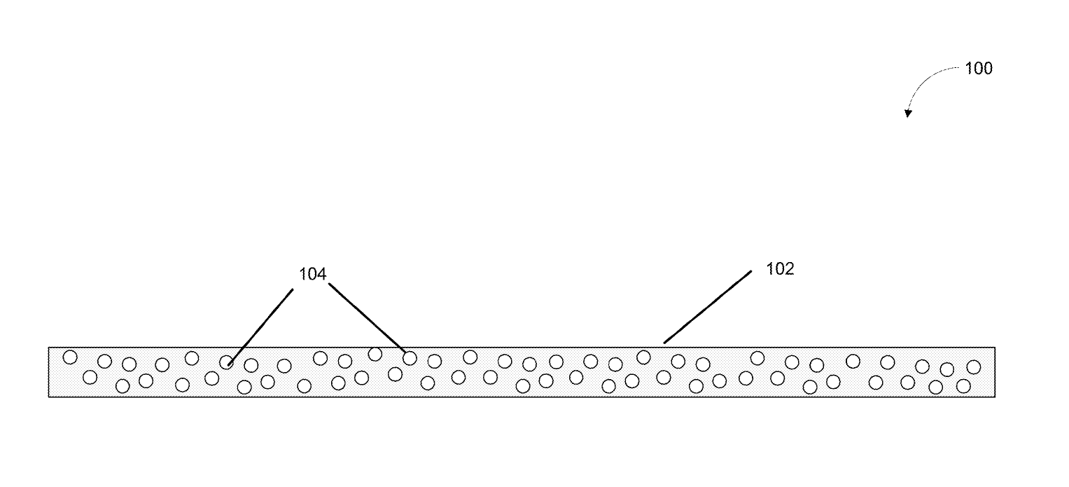

FIG. 1 illustrates an example substrate including thermo-responsive capsules, arranged in accordance with at least some embodiments as described herein. As illustrated in diagram 100, a thermostatic packaging material may be formed by suspending a plurality of thermo-responsive capsules 104 within a substrate 102. A thermostatic packaging material may be used to package temperature sensitive materials in order to maintain a substantially constant temperature of the packaged materials as an ambient temperature changes.

In an example embodiment, the substrate 102 may be a thin material composed from one or more hydrophilic monomers or polymers. For example, the thin substrate material may be a gelatin or gelatin matrix material (for example, fish or mammal derived). The gelatin material may also be a blend of monomers, polymers and copolymers, where at least one of the polymers has high water content. An example of a polymer with high water content may be polyvinyl alcohol. In some embodiments, the gelatin substrate may be thermally conductive, while in other scenarios, the gelatin substrate may be configured to be insulating.

Gelatin substrates according to example embodiments may be configured to have a typical transition temperature in a range from about 25 to about 35 degrees Celsius. Thus, the gelatin substrate may become unstable at temperatures above the transition temperature. The instability of the gelatin substrate at temperatures greater than 25 to 35 degrees Celsius may limit the use of gelatin as a packaging material. In order to increase the stability of the gelatin substrate, a cooling agent may be integrated within the gelatin substrate. The combination with the cooling agent may allow the gelatin substrate to be used as a packing material when exposed to environmental temperatures above a typical transition temperature of the gelatin substrate.

The gelatin substrate with the cooling agent may be used as a packing material for temperature sensitive materials such as food, beverages, pharmaceuticals, vaccines, biological materials, or organisms. Some example biological materials may include antibodies, blood products, organs, to name a few; and some organisms may include, bacterial samples, feeder animals, and live fish, and similar ones. The cooling agent, encapsulated within the gelatin substrate, may be selected to be a food and environmentally safe agent, for example with low or no toxicity. Thus, potential risks may be avoided if the cooling agent is exposed to the packaged materials.

According to alternative embodiments, the substrate may be integrated with a heating agent. For example, capsules encapsulating a heating agent may be configured to release the heating agent in response to environmental temperatures below the transition temperature of the capsules. Thus, a warmer temperature may be maintained for packaged materials in cooler environmental conditions. In some examples, the transition temperature may actually include a range of temperatures. For example, the capsules may become unstable (e.g., miscible in case of polymer materials) with increasing environmental temperature at an upper critical solution temperature (UCST) and again with decreasing environmental temperature at a lower critical solution temperature (LCST), and release the cooling or heating agent. Yet, the UCST and the LCST may also be the same temperature for some capsule materials.

As shown in diagram 100, the cooling or heating agent may be encapsulated within thermo-responsive capsules 104, and the thermo-responsive capsules may be suspended within the substrate 102. The thermo-responsive capsules 104 may be in a size range from about 0.5 micrometers to about 5.0 micrometers. In case of the cooling agent, the thermo-responsive capsules 104 may be configured to release the cooling agent in response to detected temperatures above their transition temperature. In case of the heating agent, the thermo-responsive capsules 104 may be configured to release the heating agent in response to detected temperatures below their transition temperature.

In a system according to embodiments, the thermo-responsive capsules 104 may be composed of a polymer material, such as poly N-isopropylacrylamide (PNIPAAm). Example PNIPAAm capsules may have a typical transition temperature in a range from about 25 to about 35 degrees Celsius, and at detected temperatures above the transition temperature, the PNIPAAm capsules may be configured to collapse and to release the encapsulated contents, which may be the encapsulated cooling agent. The thermo-responsive capsules 104 may be composed from other polymers also. An example polymer may be a copolymer composed of 95% of 2-(2-methoxyethoxy)ethyl methacrylate (MEO₂MA) and 5% of oligo(ethylene glycol) methacrylate (OEGMA, Mₙ=475 g·mol⁻¹) (P(MEO₂MA-co-OEGMA)).

In an example embodiment, the transition temperature of the PNIPAAm capsules may be adjusted in order to customize an environmental temperature at which the PNIPAAm capsules may collapse to release their encapsulated contents. The transition temperature of the PNIPAAm capsules may be adjusted by copolymerizing the PNIPAAm capsules before suspending the capsules in the substrate. For example, the transition temperature can be adjusted upward by copolymerizing the PNIPAAm capsules with a hydrophilic comonomer such as acrylamide. Copolymerization may also be used to adjust the mechanical properties such as with silica.

Similarly, the transition temperature may also be adjusted downward by copolymerizing with a hydrophobic comonomer such as polycaprolactam and polycaprolactone (PCL). The transition temperature may also be adjusted downward by integrating chitosan, polylactic acid (PLA), poly L-Lactide (PLLA), and silica for adjusting mechanical properties of the capsules. Silica may cause the capsules to be porous and PNIPAAm may be used to block the pores. The PNIPAAm may contract to reveal the pores to release the cooling agent. Further, a hybrid structure may be formed by interpenetrating the PNIPAAm capsules with one or more of polylactic acid, PLLA, silica or other polymer which may cause a larger-sized and more rigid PNIPAAm capsule, and may induce a change in permeability.

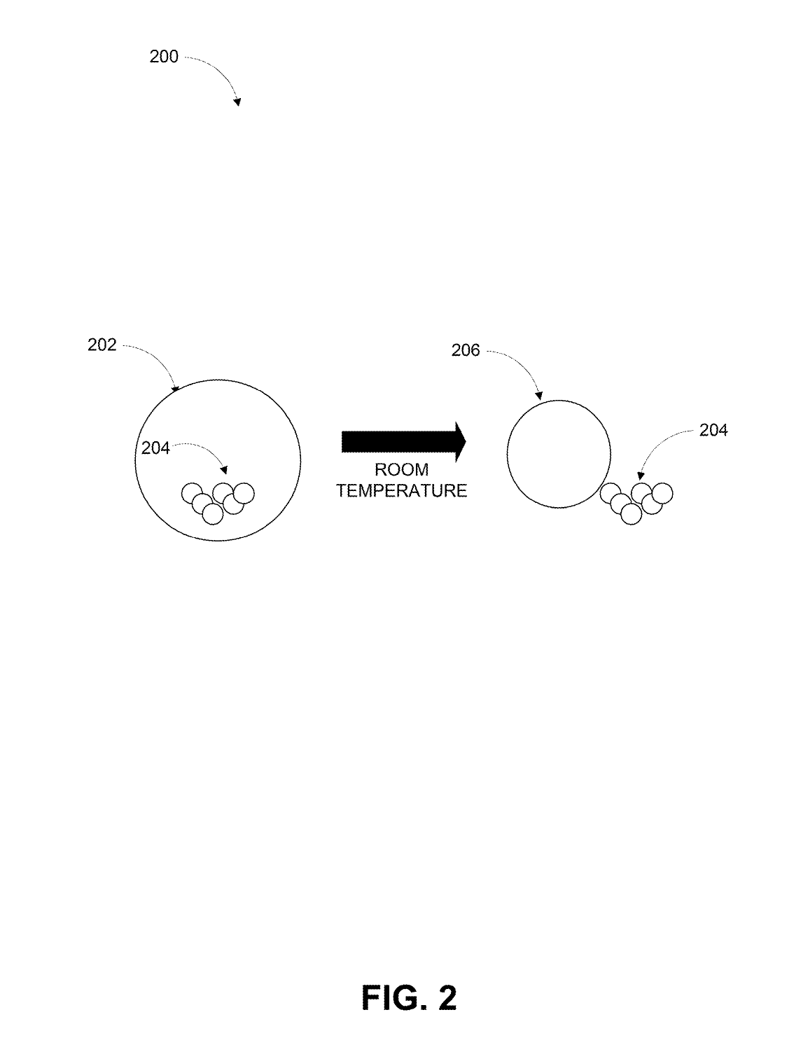

FIG. 2 illustrates example release of a cooling agent from a thermo-responsive capsule, arranged in accordance with at least some embodiments as described herein.

As shown in diagram 200, a thermo-responsive capsule 202 may be composed of a material such as a polymer with a defined transition temperature. The thermo-responsive capsule 202 may encapsulate a cooling agent or heating agent. In an example scenario, the thermo-responsive capsule may be composed such that its transition temperature is in a relatively narrow range that includes room temperature and a cooling agent is encapsulated within. Thus, above room temperature, the material forming the thermo-responsive capsule 202 may collapse such that the cooling agent molecules 204 are released to the environment from the degraded thermo-responsive capsule 206 in order to maintain the temperature of the packed item(s).

In another example scenario, the transition temperature of the thermo-responsive capsule may be selected about room temperature and a heating agent encapsulated within the thermo-responsive capsule. Thus, when the environmental temperature drops to room temperature or below, the capsule may degrade becoming permeable and the heating agent released to maintain the temperature of the packed item(s).

In an example embodiment, the thermo-responsive capsules may be composed from PNIPAAm polymer. PNIPAAm is a thermo-responsive polymer, and at temperatures above its transition temperature, which may typically be in a range from about 25 to about 35 degrees Celsius, PNIPAAm may undergo a reversible volume phase transition, causing the PNIPAAm to greatly shrink in size. In some examples, the PNIPAAm may shrink approximately nine-fold. In an example embodiment, the shrinkage of the PNIPAAm may cause the thermo-responsive capsules composed from the PNIPAAm to collapse and to release the encapsulated contents (cooling or heating agent). Additionally, the volume phase transition may also be accompanied by a hydrophilic-to-hydrophobic transition, such that as the PNIPAAm capsules decrease in volume and collapse, they also become hydrophobic.

In another example embodiment, thermo-responsive capsules may be composed from other materials such as poly L-Lactide (PLLA), silica, urethane or other similar copolymers to form rigid porous capsules. PNIPAAm may be inserted into internal cavities or pores of the rigid capsules, and as the ambient temperature increases above the transition temperature, the PNIPAAm may shrink, thereby exposing the cavities or pores of the capsules and providing release of contents encapsulated in the thermo-responsive capsules through the cavities or pores.

In another example embodiment, the cooling agent may be first encapsulated in another capsule, which may be composed from a brittle material, in order to prevent leakage of the cooling agent. The brittle capsule may be encapsulated within the PNIPAAm capsules, and when the PNIPAAm capsules shrink or collapse as previously described, the brittle capsule may be crushed to release the cooling agent. Some example materials for composing the brittle capsule may be poly urea-formaldehyde, starch, amino resin, polyamide, polyurethane, cellulose, polyvinyl acetate, urea-resourcinol formaldehyde.

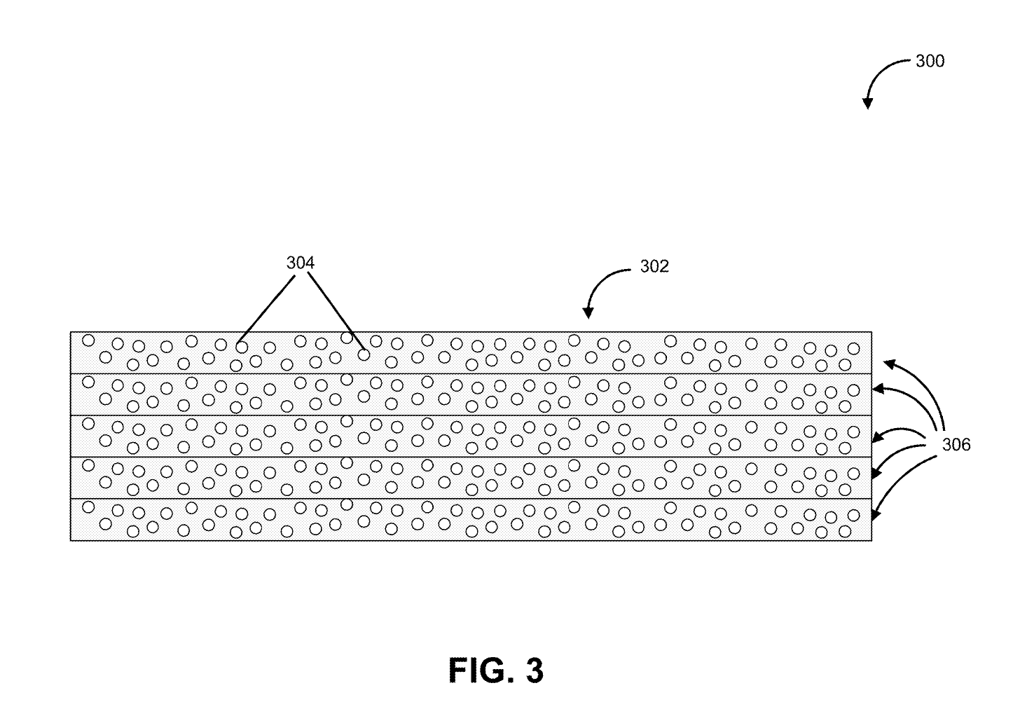

FIG. 3 illustrates a sectional view of a laminate of substrate layers including thermo-responsive capsules, arranged in accordance with at least some embodiments as described herein.

In some example embodiments, a cooling agent may be encapsulated within thermo-responsive capsules 304, which may be PNIPAAm capsules. The thermo-responsive capsules may be suspended within a substrate 302, which may be a gelatin substrate film, for example. Multiple gelatin film substrates including the suspended plurality of thermo-responsive capsules may be layered together to form a laminate 300 to act as a thermostatic packing material.

In one example embodiment, the layered laminate 300 may be employed as thermostatic packaging material for packaging temperature sensitive materials, such as food, beverages, biological materials, organisms, pharmaceuticals, and vaccines, to name a few. The layered laminate may provide a staged release mechanism for maintaining a constant temperature. The staged release mechanism may operate as follows: an outermost substrate layer may be exposed to the environment, and as an ambient temperature of the environment reaches a threshold temperature, which may be a transition temperature of the thermo-responsive capsules, the thermo-responsive capsules may collapse, thereby releasing the encapsulated cooling agents. The thermo-responsive capsules may collapse due a volume shrinkage as previously described. After a period of time the outermost substrate layer may warm to the threshold temperature, and the thermo-responsive capsules in the adjacent substrate layer may release their contents in response. This staged release mechanism may continue through the substrate layers in the laminate to maintain a desired temperature of the packaged item(s) surrounded by an inner-most layer of the laminate 300.

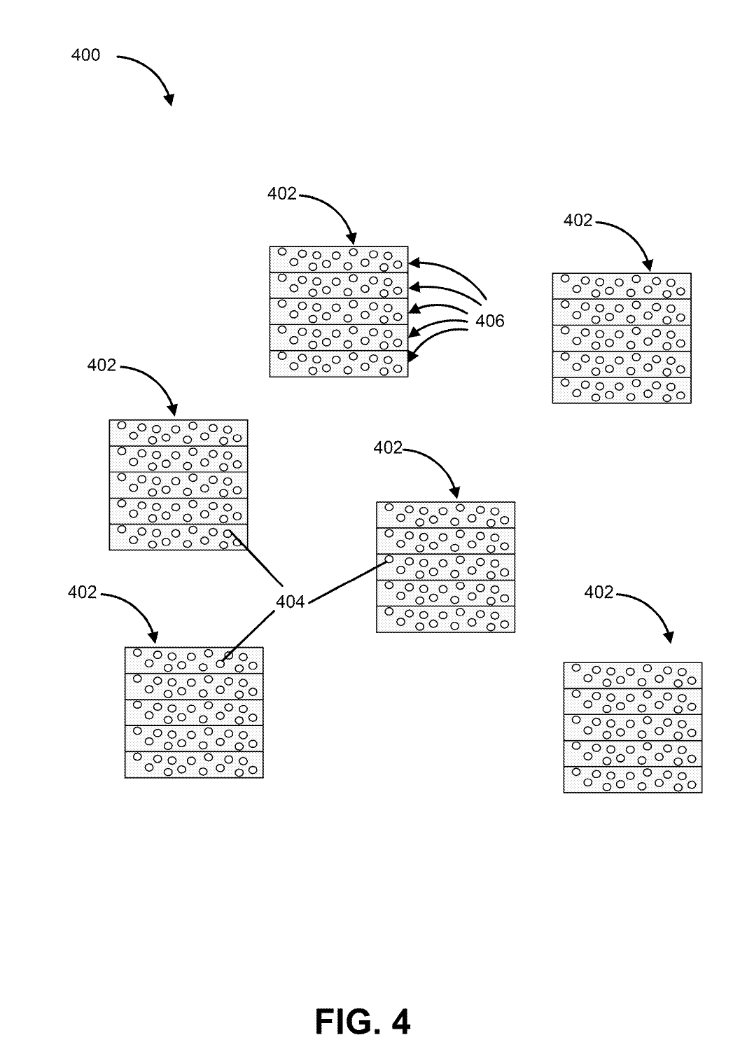

FIG. 4 illustrates example packaging material formed from cut laminate, arranged in accordance with at least some embodiments as described herein.

As previously described, a laminate composed of multiple layered substrates may be used as a packing material for temperature sensitive materials. Some example materials may include food, beverages, biological materials, organisms, pharmaceuticals, vaccines, and other temperature sensitive materials. In some example embodiments, the layered laminate may be used as a single piece of packing material surrounding the packed item(s). In other embodiments, the layered laminate may be cut into a desired size of smaller pieces 402 with each small piece 402 including layers 406 of substrate and thermo-responsive capsules 404 within each layer.

In some examples, the laminates may be cut to form boxes or trays which may contain the temperature sensitive materials. Additionally, as demonstrated in diagram 400, the laminate may be cut into smaller pieces, and/or into granulated particles of various sizes to form loose-fill packaging. The laminate may be cut into various shapes and sizes as desired based on intended usage.

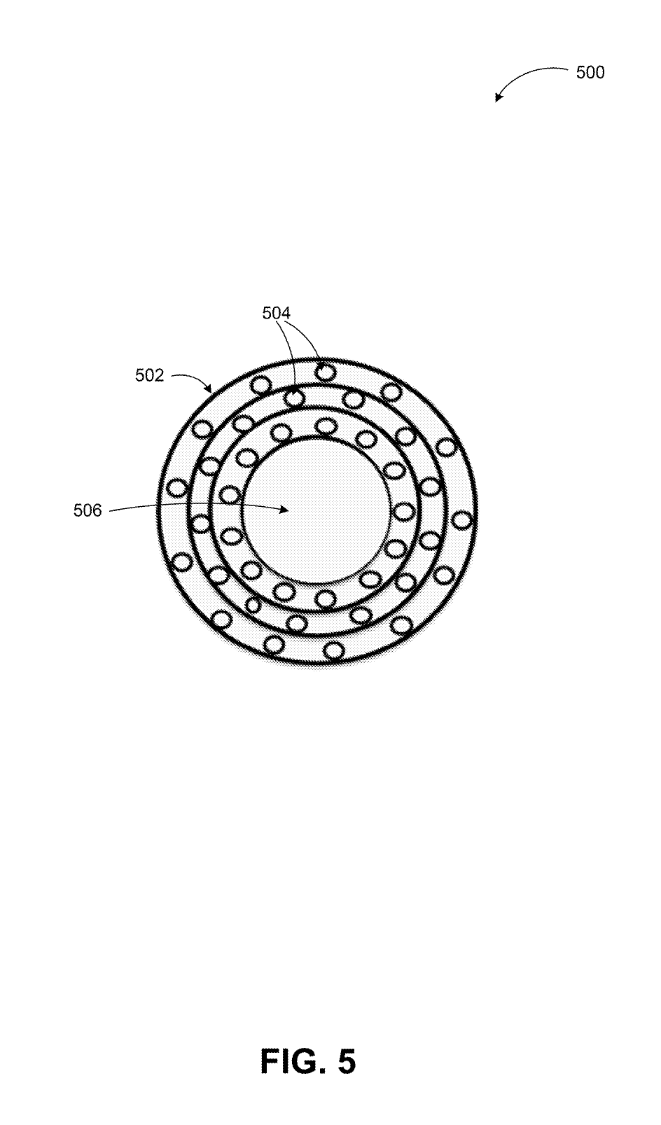

FIG. 5 illustrates an example cylindrical packaging material formed from a rolled laminate, arranged in accordance with at least some embodiments as described herein.

As demonstrated in diagram 500, a laminate 502 composed of multiple layered substrates may also be formed into a cylinder to be used as a packing material for temperature sensitive materials. As previously discussed the laminate 502 may include multiple layered gel substrates including a cooling agent encapsulated in suspended thermo-responsive capsules 504. The laminate may be rolled to substantially form a cylinder having multiple layers of the substrate, and temperature sensitive items may be inserted within a center of the cylindrical laminate. In other examples, the laminate 502 may be arranged to form a sphere or similar structure to encompass the temperature-sensitive items.

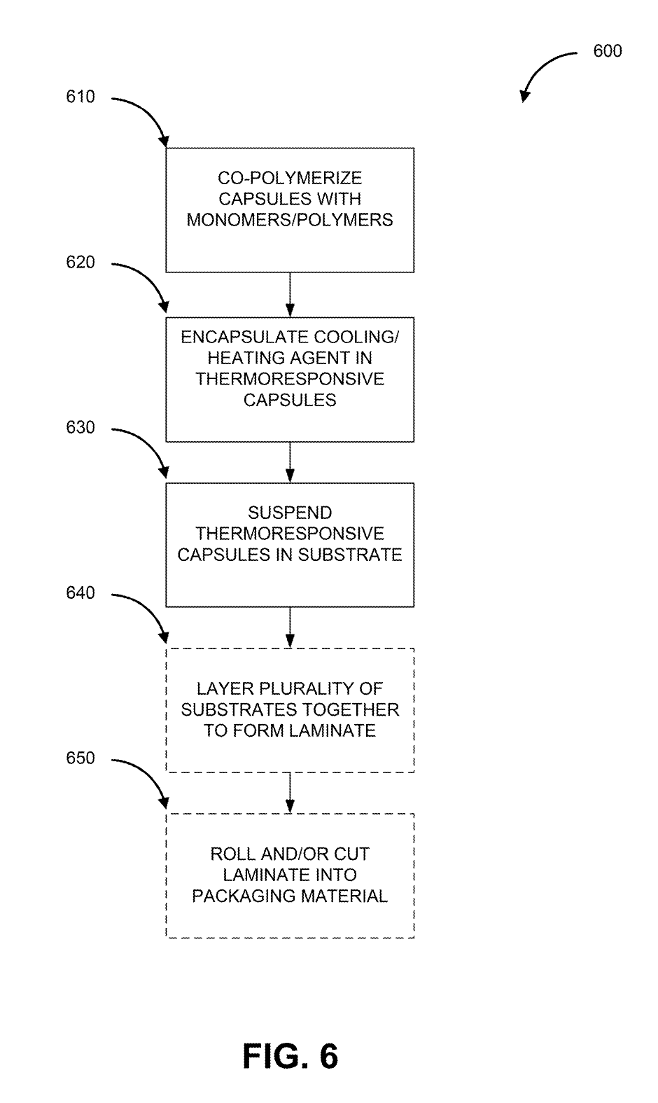

FIG. 6 illustrates an example schematic of forming thermostatic packaging materials from a layered laminate, arranged in accordance with at least some embodiments as described herein.

As illustrated in diagram 600, a laminate may be composed to form a packing material for temperature sensitive materials. At operation 610, thermo-responsive capsules may be copolymerized with one or more monomers and polymers to adjust a transition temperature and/or a transition temperature of the thermo-responsive capsules. At operation 620, a cooling agent may be encapsulated within the thermo-responsive capsules. In some example embodiments, the thermo-responsive capsules may be composed from a PNIPAAm polymer to form PNIPAAm capsules.

At operation 630, the thermo-responsive capsules may be suspended within a substrate. An example substrate may include a gelatin film or a gelatin matrix substrate. At operation 640, substrates including the suspended thermo-responsive capsules may be layered together to form a laminate. The laminate may be employed to package temperature sensitive materials. At optional operation 650, the laminate may be formed into various shapes and sizes to form packaging materials. The laminate may be rolled to substantially form a cylinder, for example, or the laminate may be cut to form lose fill packaging.

In some embodiments, the thermostatic packaging material may be “empty”, that is, does not hold temperature sensitive products such as food, beverages, biological materials, pharmaceuticals, vaccines, and live organisms. In other embodiments, at least one temperature sensitive product may be disposed within the thermostatic packaging material.

While embodiments have been discussed above using specific examples, components, and configurations, they are intended to provide a general guideline to be used for providing thermostatic packaging materials through the use of thermo-responsive capsules and cooling or heating agents. These examples do not constitute a limitation on the embodiments, which may be implemented using other components, modules, and configurations using the principles described herein. Furthermore, actions discussed above may be performed in various orders, especially in an interlaced fashion.

According to some example embodiments, the present disclosure describes a thermostatic packaging material for maintaining a constant temperature of packaged products. The thermostatic packaging material may include at least one substrate, a plurality of thermo-responsive capsules suspended within the substrate, and at least one cooling agent encapsulated within the thermo-responsive capsules.

According to some example embodiments, the substrate may be a gelatin film substrate. The substrate may be a hydrophilic polymer. The substrate may be co-polymerized with one or more monomers and polymers.

According to some example embodiments, the thermostatic packaging material may include a plurality of substrates layered to form a laminate. The substrate may be rolled to substantially form a cylinder having multiple layers of the substrate.

According to some example embodiments, the thermo-responsive capsules may be poly-N-isopropylacrylamide (PNIPAAm) capsules. The PNIPAAm capsules may be configured to release a cooling agent in response to a detected temperature greater than or equal to a transition temperature of the PNIPAAm capsules. The PNIPAAm capsules may be configured to decrease in volume and collapse in response to a detected temperature greater than or equal to the transition temperature of the PNIPAAm capsules in order to release the encapsulated cooling agent.

According to some example embodiments, the PNIPAAm capsules may be configured to become porous in response to a detected temperature greater than or equal to the transition temperature of the PNIPAAm capsules in order to release the encapsulated cooling agent. The transition temperature of the PNIPAAm capsules may be in a range from about 25 to about 35 degrees Celsius. The PNIPAAm capsules may be co-polymerized with one or more monomers and polymers to adjust the transition temperature of the PNIPAAm capsules.

According to further embodiments, the PNIPAAm capsules may be copolymerized with a hydrophilic monomer such that a transition temperature of the PNIPAAm capsules with the hydrophilic monomer has a value that may be higher than the transition temperature of the PNIPAAm capsules without the hydrophilic monomer. The hydrophilic monomer may be acrylamide.

According to some example embodiments, the PNIPAAm capsules may be copolymerized with a hydrophobic monomer or a hydrophobic polymer such that a transition temperature of the PNIPAAm capsules with the hydrophobic monomer or the hydrophobic polymer has a value that may be higher than the transition temperature of the PNIPAAm capsules without the hydrophobic monomer or the hydrophobic polymer. The hydrophobic polymer may be polycaprolactam or polycaprolactone (PCL), or combinations thereof.

According to other embodiments, the cooling agent may be a food safe agent. The cooling agent may be ammonium nitrate.

According to other embodiments, the thermo-responsive capsules may be magnetized. The magnetized thermo-responsive capsules may be removable from the substrate.

According to further embodiments, at least one food or beverage may be disposed within the thermostatic packaging material. According to other embodiments, pharmaceuticals, vaccines, biological materials, and organisms may be disposed within the thermostatic packaging material.

According to yet other embodiments, the present disclosure describes a method of forming a thermostatic packaging material for maintaining a constant temperature of packaged products. The method may include encapsulating a cooling agent within a plurality of thermo-responsive capsules, suspending the plurality of thermo-responsive capsules within a gelatin substrate film, and layering a plurality of gelatin film substrates including the suspended plurality of thermo-responsive capsules together to form a laminate.

According to yet other embodiments, the method may also include co-polymerizing the gelatin film substrate with one or more monomers and polymers prior to the layering step. The thermo-responsive capsules may be poly-N-isopropylacrylamide (PNIPAAm) capsules.

According to yet other embodiments, the method may also include configuring the PNIPAAm capsules to release the encapsulated cooling agent in response to a detected temperature greater than or equal to a transition temperature of the PNIPAAm capsules. The method may also include configuring the PNIPAAm capsules to decrease in volume and collapse in response to a detected temperature greater than or equal to the transition temperature of the PNIPAAm capsules in order to release the encapsulated cooling agent.

According to yet other embodiments, the method may also include configuring the PNIPAAm capsules to become porous in response to a detected temperature greater than or equal to the transition temperature of the PNIPAAm capsules in order to release the encapsulated cooling agent. The transition temperature of the PNIPAAm capsules may be in a range from about 25 to about 35 degrees Celsius.

According to yet other embodiments, the method may also include co-polymerizing the PNIPAAm capsules with a hydrophilic monomer such that the transition temperature of the PNIPAAm capsules with the hydrophilic monomer has a value that may be higher than the transition temperature of the PNIPAAm capsules without the hydrophilic monomer. The method may further include co-polymerizing the PNIPAAm capsules with acrylamide prior to the suspending step.

According to yet other embodiments, the method may also include co-polymerizing the PNIPAAm capsules with at least one of a hydrophobic monomer or a hydrophobic polymer such that a transition temperature of the PNIPAAm capsules with the hydrophobic monomer or the hydrophobic polymer has a value that may be higher than the transition temperature of the PNIPAAm capsules without the hydrophobic monomer or the hydrophobic polymer. The hydrophobic polymer may be polycaprolactam or polycaprolactone (PCL), or combinations thereof.

According to further embodiments, the method may also include rolling the gelatin film substrate to form a cylinder having multiple layers of the gelatin film substrate. The cooling agent may be a food safe agent. The method may also include selecting the cooling agent from ammonium nitrate.

According to further embodiments, the method may also include magnetizing the thermo-responsive capsules. The method may also include disposing at least one food or beverage within the thermostatic packaging material. The method may further include disposing one or more of: pharmaceuticals, vaccines, biological materials and organisms within the thermostatic packaging material.

According to further embodiments, the present disclosure describes a thermostatic packaging material for maintaining a constant temperature of packaged products. The thermostatic packaging material may include at least one gelatin film substrate, a plurality of thermo-responsive polymer capsules suspended within the gelatin film substrate, and at least one cooling agent or a heating agent encapsulated within the thermo-responsive polymer capsules.

According to other embodiments, the gelatin film substrate has a transition temperature in a range from about 25 to about 35 degrees Celsius. A plurality of gelatin film substrates including the suspended thermo-responsive polymer capsules may be layered together form a laminate. The laminate may be rolled to form a cylinder having multiple layers of the gelatin film substrate including the suspended thermo-responsive polymer capsules.

According to other embodiments, the thermo-responsive capsules may be poly-N-isopropylacrylamide (PNIPAAm) capsules. A transition temperature of the PNIPAAm capsules may be in a range from about 25 degrees Celsius to about 35 degrees Celsius.

According to further embodiments, the PNIPAAm capsules may be configured to release the cooling agent in response to a detected temperature greater than or equal to the transition temperature of the PNIPAAm capsules. The PNIPAAm capsules may be configured to release the heating agent in response to a detected temperature less than the transition temperature of the PNIPAAm capsules.

According to further embodiments, the PNIPAAm capsules may be configured to decrease in volume and collapse in response to a detected temperature greater than or equal to the transition temperature of the PNIPAAm capsules in order to release the encapsulated cooling agent. The PNIPAAm capsules may be configured to become porous in response to a detected temperature greater than or equal to the transition temperature of the PNIPAAm capsules in order to release the encapsulated cooling agent.

According to further embodiments, the PNIPAAm capsules may be co-polymerized with one or more monomers and polymers to adjust the transition temperature of the PNIPAAm capsules prior to the suspending step. The PNIPAAm capsules may be copolymerized with a hydrophilic monomer such that a transition temperature of the PNIPAAm capsules with the hydrophilic monomer has a value that may be higher than the transition temperature of the PNIPAAm capsules without the hydrophilic monomer. The hydrophilic monomer may be acrylamide.

According to yet other embodiments, the PNIPAAm capsules may be copolymerized with a hydrophobic monomer or a hydrophobic polymer such that a transition temperature of the PNIPAAm capsules with the hydrophobic monomer or the hydrophobic polymer has a value that may be higher than the transition temperature of the PNIPAAm capsules without the hydrophobic monomer or the hydrophobic polymer. The hydrophobic polymer may be polycaprolactam or polycaprolactone (PCL), or combinations thereof. The hydrophobic monomer may be poly L-Lactide (PLLA).

According to yet other embodiments, the cooling agent may be ammonium nitrate. At least one of: a food, a beverage, a pharmaceutical, a vaccine, a biological material, or an organism may be disposed within the thermostatic packaging material.

### EXAMPLE 1

### Packaging Food for Delivery

To ensure safe delivery of food items, a laminate may be formed from layers of gelatin substrate with suspended capsules of PNIPAAm. The PNIPAAm capsules may be formed through copolymerization with polycaproplactam such that a transition temperature of the capsules is adjusted to be near room temperature. A cooling agent such as ammonium nitrate may be encapsulated within the capsules. The laminate may be formed to fit inside a shipment box with a thickness of 10 mm and the food item to be delivered placed inside the box with the laminate. The laminate may further be encapsulated within a plastic sheathing to ensure safety of the packaged food items in case the cooling agent were to leak outside of the gelatin layers.

During delivery, as the temperature of the box reaches or exceeds room temperature, the capsules within the most outer layer of gelatin may collapse and release the cooling agent allowing the temperature exposed to the adjacent layer to remain cooler than room temperature for some time. As the temperature of the most outer layer reaches or exceeds room temperature, the adjacent layer may repeat the same process. Thus, the temperature within the box may remain below room temperature as the layers of the laminate warm up, cool (through the release of the cooling agent), and warm up again. This staged process may allow the food item to be maintained below room temperature until the item is delivered to its destination.

### EXAMPLE 2

### Planar Packaging for Biochemical Agent

A biochemical agent may denature below room temperature and may have to be shipped to a destination at a cold climate. To ensure safe delivery of the biochemical agent, the packaging box may be filled with a bag of lose gelatinous substrate containing polylactic acid (PLA) capsules. The bag may surround the bottles containing the biochemical agent and the capsules may be filled with a heating agent. An LCST of the capsules may be adjusted through copolymerization to about room temperature.

Thus, when the environment temperature drops below room temperature, the PLA capsules may expand releasing the heating agent via permeation and ensuring the temperature of the biochemical agent to remain at or above the room temperature. A volume of the bag (that is, the amount of heating agent) may be selected to ensure sufficient heating of the biochemical agent for the expected duration of the shipment.

### EXAMPLE 3

### Filler Packaging for Pharmaceuticals

To safely ship pharmaceuticals below a predefined temperature (for example, 10 degrees Celsius), a laminate of gelatin layers may be fabricated with each layer containing capsules of a hybrid structure formed by interpenetrating PNIPAAm capsules with silica. The laminate may be cut into smaller pieces of 10×10×10 mm cubes and the cubes used to fill the shipment boxes containing the pharmaceuticals. As the environment temperature reaches 10 degrees Celsius during shipment, the PNIPAAm in the capsules may shrink rendering the capsules permeable to the cooling agent encapsulated within each capsule. Once released, the cooling agent (for example, ammonium nitrate) may cool the temperature of the packaged pharmaceuticals ensuring safe delivery.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A thermostatic packaging material to maintain a constant temperature of packaged products, the thermostatic packaging material comprising:
at least one substrate;
a plurality of thermo-responsive capsules suspended within the substrate;
at least one cooling agent encapsulated within the thermo-responsive capsules; and
one or more monomers and polymers co-polymerized with the thermo-responsive capsules to enable a transition temperature of the thermo-coupled capsules to be adjusted, wherein the thermo-responsive capsules are configured to release the at least one cooling agent in response to a detected temperature greater than or equal to the transition temperature of the thermo-responsive capsules.

2. (canceled)

3. The thermostatic packaging material of claim 1, wherein the substrate is a hydrophilic polymer.

4.-6. (canceled)

7. The thermostatic packaging material of claim 1, wherein the thermo-responsive capsules are poly-N-isopropylacrylamide (PNIPAAm) capsules.

8. (canceled)

9. The thermostatic packaging material of claim 7, wherein the PNIPAAm capsules are configured to decrease in volume and collapse in response to a detected temperature greater than or equal to a transition temperature of the PNIPAAm capsules in order to release the encapsulated cooling agent.

10. The thermostatic packaging material of claim 9, wherein the PNIPAAm capsules are configured to become porous in response to a detected temperature greater than or equal to the transition temperature of the PNIPAAm capsules in order to release the encapsulated cooling agent.

11. The thermostatic packaging material of claim 9, wherein the transition temperature of the PNIPAAm capsules is in a range from about 25 to about 35 degrees Celsius.

12. (canceled)

13. The thermostatic packaging material of claim 11, wherein the PNIPAAm capsules are copolymerized with a hydrophilic monomer such that the transition temperature of the PNIPAAm capsules with the hydrophilic monomer has a value that is higher than the transition temperature of the PNIPAAm capsules without the hydrophilic monomer, and the hydrophilic monomer is acrylamide.

14. (canceled)

15. The thermostatic packaging material of claim 11, wherein the PNIPAAm capsules are copolymerized with a hydrophobic monomer or a hydrophobic polymer such that a transition temperature of the PNIPAAm capsules with the hydrophobic monomer or the hydrophobic polymer has a value that is lower than the transition temperature of the PNIPAAm capsules without the hydrophobic monomer or the hydrophobic polymer, and the hydrophobic polymer is polycaprolactam or polycaprolactone (PCL), or combinations thereof.

16. (canceled)

17. The thermostatic packaging material of claim 15, wherein the PNIPAAm capsules are copolymerized with poly L-Lactide (MLA).

18.-23. (canceled)

24. A method to form a thermostatic packaging material to maintain a constant temperature of packaged products, the method comprising:
encapsulating a cooling agent within a plurality of thermo-responsive capsules;
co-polvmerizing the thermo-responsive capsules with one or more monomers and polymers to enable a transition temperature of the thermo-responsive capsules to be adjusted, wherein the thermo-responsive capsules are configured to release the at least one cooling agent in response to a detected temperature greater than or equal to the transition temperature of the thermo-responsive capsules;
suspending the plurality of thermo-responsive capsules within a gelatin substrate film; and
layering a plurality of gelatin film substrates including the suspended plurality of thermo-responsive capsules together to form a laminate.

25. The method of claim 24 further comprising:
co-polymerizing the gelatin film substrate with one or mote monomers and polymers prior to the layering step.

26.-35. (canceled)

36. The method of claim 24, further comprising rolling the gelatin film substrate to form a cylinder having multiple layers of the gelatin film substrate.

37.-38. (canceled)

39. The method of claim 24, further comprising:
magnetizing the thermo-responsive capsules.

40. The method of claim 24, further comprising:
disposing at least one food or beverage within the thermostatic packaging material.

41. The method of claim 24, further comprising:
disposing one or more of: a pharmaceutical, a vaccine, a biological material, and an organism within the thermostatic packaging material.

42. A thermostatic packaging material to maintain a constant temperature of packaged products, the thermostatic packaging material comprising:
at least one gelatin film substrate;
a plurality of thermo-responsive polymer capsules suspended within the gelatin film substrate;
at least one cooling agent or a heating agent encapsulated within the thermo-responsive polymer capsules; and
one or more monomers and polymers co-polymerized with the thermo-responsive capsules to enable a transition temperature of the thermo-responsive capsules to be adjusted, wherein the thermo-responsive capsules are configured to release the at least one cooling agent in response to a detected temperature greater than or equal to the transition temperature of the thermo-responsive capsules.

43. The thermostatic packaging material of claim 42, wherein the gelatin film substrate has a transition temperature in a range from about 25 to about 35 degrees Celsius.

44.-51. (canceled)

52. The thermostatic packaging material of claim 42, wherein the cooling agent is encapsulated within capsules composed of a brittle material, the capsules of brittle material are encapsulated within the thermo-responsive capsules, and the thermo-responsive capsules are poly-N-isopropylacrylamide (PNIPAAm) capsules.

53. The thermostatic packaging material of claim 52, wherein the brittle capsule is composed from one or more of: poly urea-formaldehyde, starch, amino resin, polyamide, polyurethane, cellulose, polyvinyl acetate, urea-resourcinol formaldehyde.

54.-57. (canceled)

58. The thermostatic packaging material of claim 42, wherein the cooling agent is ammonium nitrate.

59. (canceled)
